(19) United States
(12) Patent Application Publication
(10) Pub. No.: US 2008/0182591 A1
(43) Pub. Date: Jul. 31, 2008

(54) Mobile Proximity-Based Notifications

(75) Inventor: Raffi Krikorian, Somerville, MA (US)

Correspondence Address: PROSKAUER ROSE LLP, ONE INTERNATIONAL PLACE, BOSTON, MA, 02110, US

(73) Assignee: Synthesis Studios, Inc., Cambridge, MA (US)

(21) Appl. No.: 11/956,018

(22) Filed: Dec. 13, 2007

Related U.S. Application Data
(60) Provisional application No. 60/869,864, filed on Dec. 13, 2006.

(51) Int. Cl. H04Q 7/20

(52) U.S. Cl. 455/456.3

(57) ABSTRACT

Described are methods and apparatuses, including computer program products, for mobile proximity-based notifications. The method includes receiving, by a mobile first device in proximity with a second device, an identifier wirelessly transmitted by the second device. The identifier is associated with a user of the second device. The method also includes determining, using an application running on the mobile first device, whether the identifier is included on a preexisting list stored on the mobile first device. The method also includes notifying a user of the mobile first device, if the identifier is included on the preexisting list, that the user associated with the identifier is in proximity to the mobile first device.

### CROSS-REFERENCE TO RELATED APPLICATION

This application claims the benefit of and priority to U.S. Provisional Application Ser. No. 60/869,864 filed Dec. 13, 2006, which is commonly owned by the applicant of the instant application and the disclosure of which is incorporated herein by reference in its entirety.

### FIELD OF THE INVENTION

The invention relates generally to methods and apparatuses, including computer program products, for mobile proximity-based notifications.

### BACKGROUND OF THE INVENTION

Cellular phones are increasingly being equipped with Global Positioning System (GPS) receivers to determine the precise physical location of a user for advertising and social networking purposes. GPS techniques require that the user's cellular phone has a network connection. This network connection is either used in “real-time” to download geographically pertinent information, or to publish one's own information for use and re-transmission to other users. Typically, GPS techniques rely on a centralized server to store and distribute all of the information.

Cellular phones are also increasingly being equipped with Bluetooth transceivers to work with a hands-free headset. The proliferation of Bluetooth has recently led to further applications for advertising and social network purposes. Advertisers typically use Bluetooth to broadcast advertisements to all Bluetooth receivers within the range of a transmission device. Social networks typically use Bluetooth to detect wireless devices and then query a centralized server that determine if a connection exists between the devices' owners' and links the two devices for communication.

### SUMMARY OF THE INVENTION

The invention, in various embodiments, features a mobile wireless device. In one aspect, the invention features a method for mobile proximity-based notifications. The method includes receiving, by a mobile first device in proximity with a second device, an identifier wirelessly transmitted by the second device. The identifier is associated with a user of the second device. The method also includes determining, using an application running on the mobile first device, whether the identifier is included on a preexisting list stored on the mobile first device. The method also includes notifying a user of the mobile first device, if the identifier is included on the preexisting list, that the user associated with the identifier is in proximity to the mobile first device.

In another aspect, the invention features a method for mobile proximity-based notifications. The method includes wirelessly transmitting, by a first device, an identifier associated with a user of the first device. The method also includes receiving, by a mobile second device in proximity with the first device, the identifier, and determining, using an application running on the mobile second device, whether the identifier is included on a preexisting list stored on the mobile second device. The method also includes notifying a user of the mobile second device, if the identifier is included on the preexisting list, that the user associated with the identifier is in proximity to the mobile second device.

In yet a further aspect, the invention features a computer program product. The computer program product is tangibly embodied in an information carrier and includes instructions being operable to cause a data processing apparatus to receive, by a mobile first device in proximity with a second device, an identifier wirelessly transmitted by the second device. The identifier is associated with a user of the second device. The instructions are also operable to cause the data processing apparatus to determine, using an application running on the mobile first device, whether the identifier is included on a preexisting list stored on the mobile first device. The instructions are also operable to cause the data processing apparatus to notify a user of the mobile first device, if the identifier is included on the preexisting list, that the user associated with the identifier is in proximity to the mobile first device.

In another aspect, the invention features an apparatus for mobile proximity-based notifications. The apparatus includes a mobile first device adapted to receive an identifier wirelessly transmitted by a second device in proximity with the mobile first device. The identifier is associated with a user of the second device. The mobile first device is also adapted to determine, using an application running on the mobile first device, whether the identifier is included on a preexisting list stored on the mobile first device. The mobile first device is also adapted to notify a user of the mobile first device, if the identifier is included on the preexisting list, that the user associated with the identifier is in proximity to the mobile first device.

In other examples, any of the aspects above or any apparatus or method described herein can include one or more of the following features. In various embodiments, the mobile first device can include: a phone, a laptop, or a digital camera. In one embodiment, the second device can include a mobile second device. In a second embodiment, the second device can include a location-based second device. The second device can include: a phone, a laptop, a personal computer, or a digital camera. Receiving the identifier can include using Bluetooth and/or wireless USB. The identifier can be a unique ID. The identifier can be a standardized ID. The first and second devices can communicate with each other using Bluetooth and/or wireless USB.

In some embodiments, the method can further include transmitting metadata between the mobile first device and the second device. Transmitting the metadata can be in response to a request from the first or second device. In one embodiment, the method can further include rendering the metadata for display to the user of the mobile first device or the user of the second device. In another embodiment, the method can further include storing the metadata for local querying at a later time. In yet another embodiment, the method can further include transmitting the metadata to a third device when the third device is in proximity with the first or second device.

In various embodiments, the user of the mobile first device and/or the user of the second device can be a person. In some embodiments, the user of the second device can include an event and/or a space. The space can include a store. In another embodiment, the method can further include seeding the preexisting list with contacts from: an address book, a social network list, or any combination thereof. In various embodiments, the mobile first device can be in proximity with the second device when the mobile first device is within up to 100 meters of the second device.

Advantages of the invention can include one or more of the following. Reliance on a preexisting list on a mobile wireless device allows the device to not require a real-time connection to a network or to a centralized server to store and retrieve certain information. Furthermore, the present invention allows mobile wireless devices to operate in areas where GPS and cellular networks may not reach, for example, indoors, in a subway, in remote locations, etc. In addition, privacy implications involved in uploading one's positional and/or other information to a central server are eliminated by using direct proximity-based interactions among wireless devices.

The present invention can also be advantageously used in localized areas ranging from about 1 meter up to 100 meters or more. Furthermore, mobile proximity-based notifications can include the ability to transmit information between proximate parties. Modern cellular devices, laptops and other mobile devices can also easily be equipped with proximity-based transceivers. In addition to specific users, the present invention can also apply to events and/or spaces that are not associated with a precise geographic location.

The details of one or more examples are set forth in the accompanying drawings and the description below. Further features, aspects, and advantages of the invention will become apparent from the description, the drawings, and the claims. The drawings are not necessarily to scale, emphasis instead generally being placed upon illustrating the principles of the invention.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIGS. 1A-1C are block diagrams showing exemplary networks with devices relating to mobile proximity-based notification.

FIG. 2 is a flowchart depicting mobile proximity-based notification.

FIG. 3 illustrates an exemplary contact list for mobile proximity-based notification.

### DESCRIPTION OF THE INVENTION

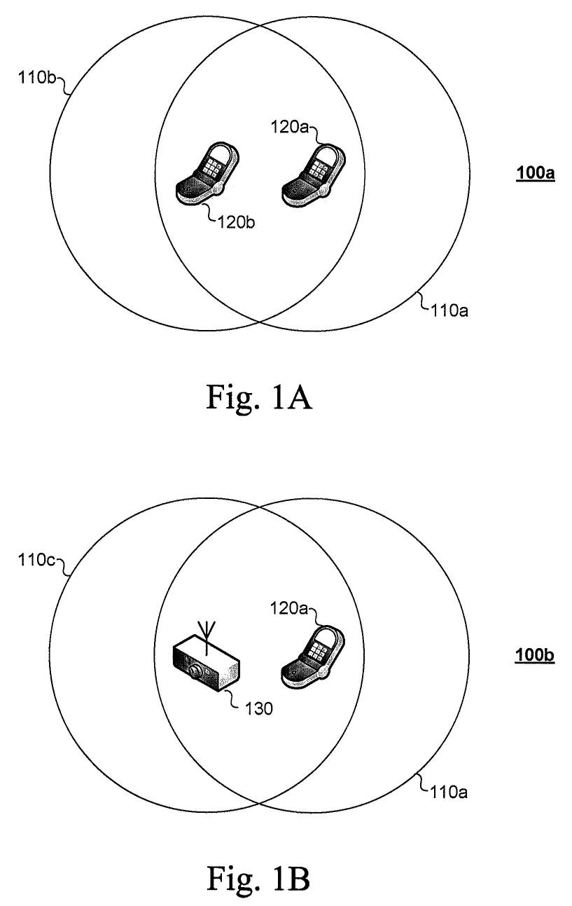

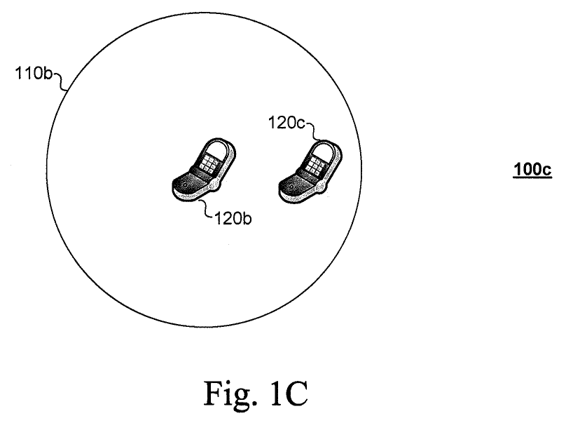

FIGS. 1A-1C are block diagrams showing exemplary networks 100a, 100b and 100c with devices relating to mobile proximity-based notification. The network 100a includes proximity-based wireless networks 110a and 110b, generally 110, respectively associated with mobile wireless devices 120a and 120b, generally 120. The transmission area and location of a proximity-based wireless network 110 is determined, respectively, by the transmission strength and location of the associated mobile wireless device 120. The transmission area of a proximity-based wireless network 110 can be a localized range from about 1 meter to about 100 meters. A mobile wireless device 120 includes a transmitter and a receiver (i.e., a transceiver).

A proximity-based wireless network 110 is responsible for the transmission of information from the associated mobile wireless device 120 to one or more other mobile wireless devices 120, and/or other wireless devices, within the transmission range of the proximity-based wireless network 110. Information transmission and reception over a proximity-based wireless network 110 can be based on one or more wireless communication protocols. Wireless communication protocols can include, for example, Bluetooth, wireless USB, and/or other local area wireless communication protocols. Bluetooth and wireless USB advantageously allow use of proximity-based networks 110 in any location, including indoors, in underground subways/tunnels, remote locations, and other locations where GPS and cellular network signals fail to reach. Class 1, 2, and 3 Bluetooth devices can respectively transmit information to devices within, and up to, about 100 meters, about 10 meters, and about 1 meter. Wireless USB devices can transmit information to devices within and up to about 10 meters.

In the network 100a, two mobile wireless devices 120a and 120b are illustrated to be included, but other configurations can also be used. For example, network 100b includes the mobile wireless device 120a associated with proximity-based wireless network 110a, and a location-based wireless device 130 associated with proximity-based wireless network 110c. Location-based wireless device 130 can be located at specific and/or fixed locations. In another example, network 100c includes mobile wireless devices 120b and 120c. Mobile wireless device 120c includes a receiver for receiving wireless transmissions, but does not include a transmitter, in which case the device is not associated with its own proximity-based network 120. The mobile wireless device 120c only receives information when inside the proximity-based wireless network 110b of mobile wireless device 120b. In general, networks can include any number or combination of wireless devices, mobile or location based, with or without a transmitter.

A mobile wireless device 110 can be a cellular phone, a laptop, a PDA, a digital camera, or any other mobile wireless device. Location-based wireless device 130 can be a computer or any other wireless device fixed to a location. A mobile wireless device 110 and/or a location-based wireless device 130 can be identified by a unique and/or a standardized identifier. For example, a unique identifier can be a Bluetooth ID, a MAC address, or other unique identifier. A standardized identifier, for example, can be associated with one or more devices, locations, events and/or labeled spaces. In one example, a standard identifier can be associated with all store and/or office locations of a certain company or organization. In a mobile-location example, a standard identifier can be associated with all mobile blood-drive trucks. In a labeled space example, a standard identifier can be associated with a “silence your ringer” space that can be applied at the library or at the symphony hall.

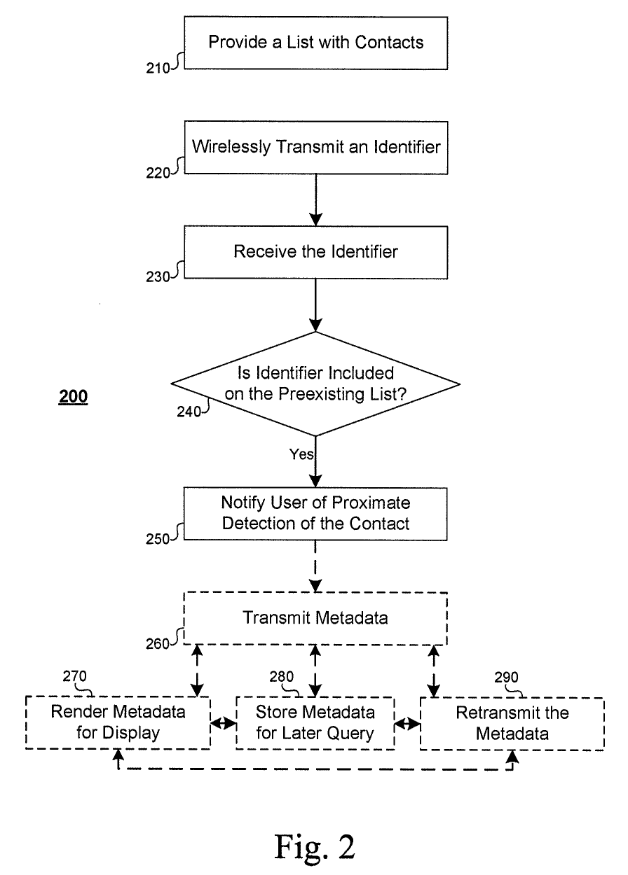

FIG. 2 is a flowchart 200 depicting mobile proximity-based notification. The elements of the flowchart 200 are described using the exemplary network 100a of FIG. 1A, but other networks can be used, such as networks 100b and 100c. Mobile proximity-based notification includes providing a list of contacts to the mobile wireless device 120a (210), wirelessly transmitting to the proximity-based wireless network 110b an identifier by the mobile wireless device 120b (220), receiving the identifier by the mobile wireless device 120a (230), determining whether the identifier is included on the preexisting list (240), and/or notifying a user of the mobile wireless device 120a of proximate detection of a contact (250). Mobile proximity-based notification can further include transmitting metadata and/or other information between the mobile wireless devices 120a and 120b (260), rendering the metadata for display (270), storing the metadata for later query (280), and/or retransmitting the metadata (290).

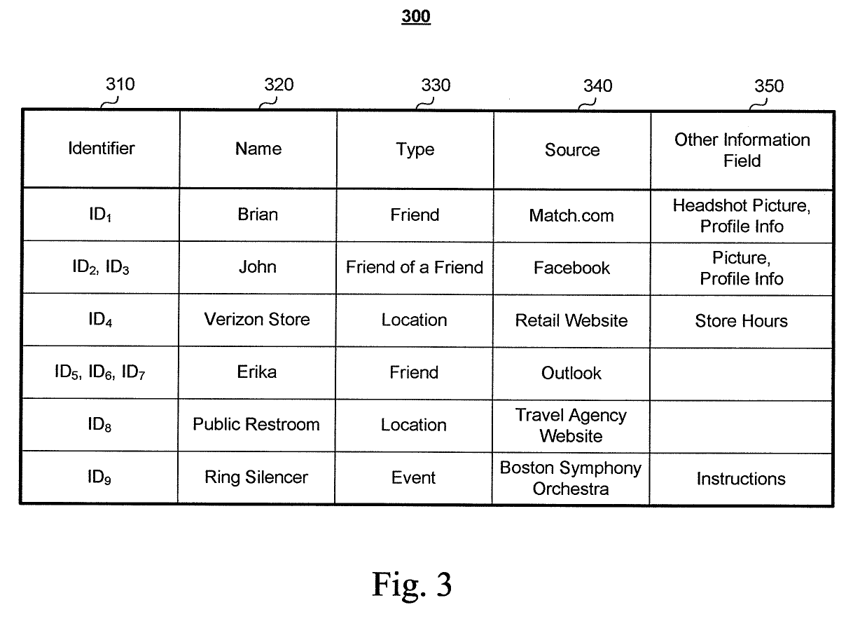

FIG. 3 illustrates an exemplary contact list 300 for mobile proximity-based notification. The contact list 300 includes an identifier field 310, a name field 320, a type field 330, a source field 340, and/or an other information field 350. The identifier field 310 can include entries of one or more identifiers (e.g., Bluetooth IDs). Each entry in the identifier field 310 can be associated with an entry in the name field 320. The name field 320 can include personal names, location-based names, event names, space names, and/or other names. For example, the identifier ID₄ can be associated with all Verizon Service Stores in one or more regions. In another example, identifier ID₅ can be associated with Erika's cell phone, identifier ID₆ can be associated with Erika's blackberry, and identifier ID₇ can be associated with Erika's laptop. The type field 330 can indicate the type of contact associated with the respective name entry. The source field 340 can indicate one or more sources of the identifier and/or name contact information associated in respective row entries. The other information field 350 can include one or more other fields and/or can include any other information provided with the respective entry. For example, upon providing an entry for John in the list of contacts 300 on the mobile wireless device 120a, Facebook.com can also send John's picture and/or other information from John's Facebook profile to be included in the other information field 350.

Providing a list of contacts to the mobile wireless device 120a (210) includes locally storing the list in memory on the mobile wireless device 120a. Providing the list can also generally include either generating a new list of contacts and/or modifying a preexisting stored list of contacts on the mobile wireless device 120a. Providing the list can include, for example, manually editing the contact list by a user using the mobile wireless device 120a. In another example, providing the list can include receiving the list, or a portion thereof to be added to a preexisting list on the mobile wireless device 120a, from a remote server or from a proximate wireless device 120 or 130. Access to the remote server can be via a cellular or broadband wireless network used by the mobile wireless device 120a. Providing the list by a remote server can occur at specified and/or at periodic times, or by request. In one example, the remote server can be associated with the email system used by the user of the mobile wireless device 120a and send contacts included in the user's address book (e.g., all contacts in the user's Outlook account, or Gmail account). In another example, the remote server can be associated with a social networking site used by the user of the mobile wireless device 120a. Social networking sites can include MySpace, Facebook, LinkedIn, any online dating service, and/or any other social networking services. The social networking server, for example, can send contacts included in the user's contact list (e.g., all friends, friends of friends, and/or date matches, etc.). In yet further examples, the remote server can be associated with other services that the user of the mobile wireless device 120a has an account with (e.g., flickr, HeyLetsGo).

Wireless transmission by the mobile wireless device 120b of its identifier to the proximity-based wireless network 110b (220) can occur continuously, at specified or periodic times, and/or at times dependent on the remaining battery power left for the mobile wireless device 120b. For example, a location-based wireless device 130 associated with a public restroom can be programmed to broadcast its identifier every 30 seconds during the hours of operation of the building for which it is located. The mobile wireless device 120a can continuously, at specified or periodic times, upon request, and/or at times dependent on the remaining battery power left for the mobile wireless device 120a, scan for proximate-based transmissions including an identifier.

Determining whether a received identifier is included on the preexisting list (240) is performed by an application running on the mobile wireless device 120a. The application can further determine whether the associated contact, if any, is with a person, a location, a space, and/or an event. For example, if the identifier received is ID₆, then the application can determine that ID₆ is included on the list 300 and that ID₆ is associated with Erika. If the received identifier does match an identifier on the preexisting list, the application can generate a notification message based on one or more associated fields of the identifier in the preexisting list. For example, the message can state that “Your friend Erika is nearby” and include Erika's picture. The mobile wireless device 120a can include default notification message generating instructions based on a type of the contact, a source of the contact, or other type of information characterizing the contact. In some embodiments, one or more specific contacts can include specific message notification settings in the other information field 350. For example, the Verizon Store can include instructions to direct the phone to play a distinctive tune to indicate to the user that a store is nearby. The application can further determine if the matched contact includes any instructions that should be locally executed. For example, if the received identifier was ID₁, then the other information field 350 for Brian can include instructions to connect to a Match.com server to download existing or updated profile information for Brian. In another example, if the received identifier was ID₉, then the “Ring Silencer” contact can include instructions in the other information field 350 to direct the application to turn off the ringer of the mobile wireless device 120a until the device leaves the proximity-based wireless network 110b or another condition(s) is met (e.g., after an elapsed amount of time).

Notifying a user of the mobile wireless device 120a of proximate detection of a contact (250) can include using a graphical user interface to deliver a visual notification message, using a speaker to deliver an audio notification message, vibrating the mobile wireless device 120a, and/or any other notification method.

Transmitting metadata and/or other information between the mobile wireless devices 120a and 120b (260) can be initiated by the application based on a proximity detection that matched a contact on the list, by an instruction from the user of the wireless device 120a, and/or can be in response to a query or request by another mobile wireless device 120. For example, the user of the wireless device 120a can include instructions in the other information field 350, associated with John, to transmit metadata to John's mobile wireless device 120b indicating that the user is nearby. In another example, after receiving a notification message indicating that Brian is nearby, the user of the mobile wireless device 120a can manually instruct a message to be sent to Brian including a picture and a short message. Metadata can be encoded in a human readable name of a mobile wireless device 120. Other information can include, for example, advertisements for a store, text or IM messages, or other real-time communications. In one embodiment, the user of mobile wireless device 120a can elect to receive advertisements/special offers when he or she comes within proximity of a Verizon Store. In this case, the mobile wireless device 120a can transmit a message to the location-based wireless device 130, based on an instruction in the other information field 350, and the location-based wireless device 130 at the Verizon Store can send advertisement messages in response. Elective advertisements advantageously allow passive, unobtrusive advertisements to consumers.

A mobile wireless device 120 that receives metadata and/or other information, depending on what application is running on the device, can determine what to do with the received metadata. The application can render the metadata for display (270) and display the information visually and/or aurally. The application can store the metadata for later query (280). The application can also retransmit the metadata (290) to one or more other wireless devices 120 and/or 130 that enter the proximity-based network 110a.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and the computer program can be deployed in any form, including as a stand-alone program or as a subroutine, element, or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by, and an apparatus can be implemented as, special purpose logic circuitry, e.g., an FPGA (field programmable gate array) or an ASIC (application-specific integrated circuit). Subroutines can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and/or data. Generally, a computer also includes, or is operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD, DVD, HD-DVD, and Blu-ray disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A method for mobile proximity-based notifications, the method comprising:
receiving, by a mobile first device in proximity with a second device, an identifier wirelessly transmitted by the second device, the identifier being associated with a user of the second device;
determining, using an application running on the mobile first device, whether the identifier is included on a preexisting list stored on the mobile first device; and
notifying a user of the mobile first device, if the identifier is included on the preexisting list, that the user associated with the identifier is in proximity to the mobile first device.

2. The method of claim 1 wherein the mobile first device comprises: a phone, a laptop, or a digital camera.

3. The method of claim 1 wherein the second device comprises a mobile second device.

4. The method of claim 1 wherein the second device comprises a location-based second device.

5. The method of claim 1 wherein the second device comprises: a phone, a laptop, a personal computer, or a digital camera.

6. The method of claim 1 wherein receiving the identifier comprises using Bluetooth or wireless USB.

7. The method of claim 1 wherein the identifier is a unique ID.

8. The method of claim 1 wherein the identifier is a standardized ID.

9. The method of claim 1 wherein the first and second devices communicate with each other using Bluetooth or wireless USB.

10. The method of claim 1 further comprising transmitting metadata between the mobile first device and the second device.

11. The method of claim 10 wherein transmitting the metadata is in response to a request from the first or second device.

12. The method of claim 11 further comprising rendering the metadata for display to the user of the mobile first device or the user of the second device.

13. The method of claim 11 further comprising storing the metadata for local querying at a later time.

14. The method of claim 11 further comprising transmitting the metadata to a third device when the third device is in proximity with the first or second device.

15. The method of claim 1 wherein the user of the mobile first device or the user of the second device is a person.

16. The method of claim 1 wherein the user of the second device comprises an event or a space.

17. The method of claim 16 wherein the space comprises a store.

18. The method of claim 1 further comprising seeding the preexisting list with contacts from: an address book, a social network list, or any combination thereof.

19. The method of claim 1 wherein the mobile first device is in proximity with the second device when the mobile first device is within up to 100 meters of the second device.

20. A method for mobile proximity-based notifications, the method comprising:
wirelessly transmitting, by a first device, an identifier associated with a user of the first device;
receiving, by a mobile second device in proximity with the first device, the identifier;
determining, using an application running on the mobile second device, whether the identifier is included on a preexisting list stored on the mobile second device; and
notifying a user of the mobile second device, if the identifier is included on the preexisting list, that the user associated with the identifier is in proximity to the mobile second device.

21. A computer program product, tangibly embodied in an information carrier, the computer program product including instructions being operable to cause a data processing apparatus to:
receive, by a mobile first device in proximity with a second device, an identifier wirelessly transmitted by the second device, the identifier being associated with a user of the second device;
determine, using an application running on the mobile first device, whether the identifier is included on a preexisting list stored on the mobile first device; and
notify a user of the mobile first device, if the identifier is included on the preexisting list, that the user associated with the identifier is in proximity to the mobile first device.

22. An apparatus for mobile proximity-based notifications, the apparatus comprising a mobile first device adapted to:
receive an identifier wirelessly transmitted by a second device in proximity with the mobile first device, the identifier being associated with a user of the second device;
determine, using an application running on the mobile first device, whether the identifier is included on a preexisting list stored on the mobile first device; and
notify a user of the mobile first device, if the identifier is included on the preexisting list, that the user associated with the identifier is in proximity to the mobile first device.
